(19) United States
(12) Patent Application Publication
(10) Pub. No.: US 2010/0239855 A1
(43) Pub. Date: Sep. 23, 2010

(54) TOOL

(75) Inventors: Benno Gries, Wolfenbuttel (DE); Leo Prakash, Rottenburg (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 12/681,244

(22) PCT Filed: May 26, 2008
(86) PCT No.: PCT/EP08/04166

§ 371 Date: May 10, 2010

(30) Foreign Application Priority Data
Oct. 2, 2007 (DE) 10 2007 047 312.7

(51) Int. Cl. B32B 15/04; B22F 3/12; B22F 3/26

(52) U.S. Cl. 428/336; 428/457; 419/27; 419/23; 428/472; 428/472.2; 428/334; 428/335

(57) ABSTRACT

Coated metal cutting tools with reduced adhesion weat and improved thermal resistance, processes for making the same and methods of use.

### TECHNICAL FIELD

The present invention refers to a coated metal cutting tool with reduced adhesion wear and increased thermal resistance, particularly a hard metal tool to machine alloys such as steels, cast irons, precious steels, as well as non-ferrous basic alloys, such as super alloys.

### STATE-OF-THE-ART

Hard metal tools for metal cutting are composite materials and consist of at least two phases, one of which is the binder phase and one or more are the hard material phase(s). In particular, the following materials are possible as hard materials: tungsten, molybdenum, titanium, zirconium, hafnium, chrome, vanadium, niobium, and tantalum. The binder phase generally consists of cobalt and, depending on the carbon activity during sintering, contains shares of such refractory metals, the free enthalpies of formation of which are sufficiently low to decompose into the metallic form during sintering, particularly W, Cr, and Mo.

Along with cobalt, the binder phase may also contain Fe and Ni, or only Fe and Ni and no cobalt at all. Such binder systems have their advantages in the field of toxicology, because the contact corrosion of the same is lower than with pure cobalt when making contact with carbides. On the basis of the better availability of Fe and Ni there have been many tests in the past dealing with the implementation of FeCoNi- or FeNi-based binder systems in hard metal cutting tools, at which the aforementioned was not successful up to this point in time from a technical point of view as opposed to other hard metal applications.

In sintered condition the binder phase comprises the hard material phase that may have a size of between 10 and 0.05 μm determined on the basis of optical or electron-optical methods after sintering—depending on the cutting assignment. This size is mainly adjusted by the fineness of the used hard material powders.

Cutting tools are characterised by a more defined geometry, the assignment of which for example is to insert the tool into a tool support accepting the cutting forces in a non-positive manner, to have the chip be formed and broken in a targeted manner, and to dissipate the resulting heat together with the chip removal, if possible. So-called replaceable cutting inserts are characterised by basic geometries derived from a rectangular prism or a plate, often with a hole arranged in the centre, and one or several cutting edges with a honing produced in a targeted manner. Other cutting tools, such as for example for separating, are self-supporting thanks to their geometry and only dispose of one cutting edge. Often, the surface is also characterised by pimples or reliefs, in order to minimise the contact area of the chip with the cutting tool. The selection of the proper geometry is extremely important for the lifetime of the tool, the surface quality upon cutting, and the safety of the chip breakage.

The dissertation Preikschat (Technische Universitat Karlsruhe 1994 respectively KfK 3550, ISSN 0303-4003) describes cutting tests with uncoated hard metal tools with FeCoNi binders on grey cast iron GG30. The lifetime of the tools was determined on the basis of the strong adhesion wear and the high cutting forces resulting thereof, at which a binder system with martensitic structure shows less wear on the basis of the higher binder strength than a comparable tool that had a purely cubic area-centred grid as binder phase (austenite). However, the lifetime curve of the austenitic binder—assuming a lower level—was flatter than the curve of a martensitic binder, i.e. more favourable at higher cutting speeds. Both binder systems were clearly inferior to pure cobalt as binder phase for the used hard metal tools on the basis of the adhesion wear.

Along with adhesion wear, the thermal resistance is also very important for the lifetime of cutting tools. The cutting edge generating the chips due to shearing when engaged is heated very strongly and is exposed to a strong mechanic shear load. The combination of the aforementioned results in plastic creepage and the cutting edge being lowered if the high-temperature creep strength is not sufficient for the given application case. In this, turning operations in continuous engagement with high feeds, high-strength alloys, and dry processing are particularly critical, where the tool cannot be cooled down sufficiently. As determining the thermal resistance respectively creep strength is a very time-consuming procedure, the thermal hardness is measured practically as reference variable, partially the time dependence of the same as well. As is generally known from the field of physical metallurgy the thermal hardness of Fe, Co, or Ni basic alloys can be increased by adding the elements of the auxiliary group 6a of the periodic table to the alloy. In case of the hard metal production with cobalt as binder, up to approx. 6 weight % of tungsten can be added to the binder by controlling the carbon potential during sintering, which results in hard metal tools with extraordinary thermal resistance respectively thermal hardness. In binder systems on the basis of FeCoNi with low cobalt contents and particularly on the basis if FeNi less and less tungsten is dissolved with a reduction of the cobalt content so that the thermal resistance values of these binder alloys are generally not sufficient for machining procedures. At a temperature of 1250° C. the solubility of WC in Fe, Co, respectively Ni is 7, 22, respectively 12 weight percent, which additionally depends on the carbon content. Thus, experts argue that a decrease in thermal hardness can be expected when the cobalt content is reduced and, thus, an increasingly lesser suitability as binder phase for hard metal tools for metal cutting. As the costs of the binder phase and the hazards for the health due to corresponding grinding dust during final processing increase with an increase of the cobalt content, there is the interest to reduce the cobalt content of the binder phase when producing metal cutting tools, if possible.

While hard metals with pure Fe and pure Co binders are characterised by a good course of the thermal hardness value, hard metals with a pure Ni binder are strongly inferior. The reason for the aforementioned is the high ductility of nickel.

The dissertation Prakash (Leo J. Prakash, Universitat Karlsruhe 1979, faculty of mechanical engineering KfK 2984) describes that increasing the thermal hardness of hard metals on WC basis with FeCoNi binders can be implemented by adding Cr and/or Mo to the alloy. Up to a temperature of 600° C., the thermal hardness is predominantly determined by the high-temperature properties of the binder. Above the temperature mentioned above it is determined by the structure of the hard material skeleton resulting from the used hard material powders. However, individual binder alloys on the basis of FeCoNi with cobalt contents of less than 40% achieved thermal hardness values equal or even superior to the values of pure cobalt binders between 400 and 800° C. without adding further elements to the alloy, e.g. FeCoNi 70/15/15, 65/20/15, and 25/25/50 respectively 50/25/25, irrespective of the lower densities of the binder alloy compared to cobalt and, thus, the higher volume contents of the binder in the hard metal. Thus, such binder alloys are principally suitable to resist the strains at the cutting edge as good as cobalt does, or the same are even clearly superior in case of the alloy mentioned last.

The behaviour of the two austenitic binder phases FeCoNi 25/25/50 and 50/25/25 as regards to the course of the hardness depending on the temperature is noticeable: although the initial level of hardness at room temperature is comparatively low, a value is reached at a temperature of 800° C. that is even exceeding the value of cobalt as binder phase. The reduction is monotonous and uniform, while cobalt and particularly the hard metals with martensitic binder phases are characterised by a non-uniform course. The reason could be the temperature-related, increased conversion of the martensite into austenite, destabilising the structure and facilitating creeping procedures and, thus, reducing the measured thermal hardness. However, the dissertation Preikschat clearly shows that an austenitic binder phase has less to counter the adhesion wear on the basis of its lower strength values. Thus, advantages in the fields of thermal hardness respectively creep strength may not be claimed.

Along with the already mentioned additional elements Cr and Mo, Re and Ru can also be used to increase the thermal resistance. The carbon content of binder alloys on the basis of Fe, Co, Ni containing high amounts of Fe increases the thermal hardness as well. Naturally, a sintered hard metal with both a pure Co and a FeCoNi or FeNi binder always contains shares of dissolved carbon and/or tungsten. The concentration of these elements has to be adjusted in a targeted manner, which is implemented by controlling the carbon balance during mixture preparation and sintering, and by measuring the density and the magnetic properties of the sintered object, often also by measuring the carbon content. If the carbon content is too high or too low, the same will result in the formation of hazardous so-called “Eta phases” respectively in carbon separations that are classified in accordance with ISO 4505. Both are highly disadvantageous. Hard metal with high thermal hardness values is produced preferably by using a high tungsten concentration within the binder, because this increases the thermal hardness, particularly at the border to the eta phase. With the carbon content specified, the solubility limits of other elements such as Cr and Mo in the binder metal phase are determined by the fact that the eta phase occurs above the solubility limits.

Additionally, in case of hard metal tools with interrupted engagement, as is the case with interrupted turning or milling, the thermal shock resistance plays a role. This variable depends on physical variables such as expansion coefficient, thermal conductivity, and tensile strength at high temperatures. A lack of thermal shock resistance can be seen on the basis of so-called comb cracks at the cutting edge.

### SHORT DESCRIPTION OF THE INVENTION

The invention refers to hard metal tools, particularly replaceable cutting inserts or other machining tools with the following properties:

1. Hard metal tools with a geometry suitable for metal machining, a coating suitable for metal machining, at least one hard material phase, as well as a single- or multiple-phase binder characterised by the fact that the share of the elements iron (Fe), cobalt (Co), and nickel (Ni) in the overall quantity of these elements within the binder phase is between 0 and 40 weight % for Co, preferably between 5 and 40 weight %, between 20 and 90 weight % for Fe, and between 5 and 75 weight % for Ni, at which the shares add up to 100%.

2. Hard metal tool in accordance with item 1, characterised by the fact that the binder phase, resulting from the sintering procedure, is alloyed with tungsten at a content resulting in the effect that neither eta phases nor carbon separations are contained.

3. Hard metal tool in accordance with item 1 or 2, characterised by the fact that the binder phase, resulting from the sintering procedure, is alloyed with Cr and/or Mo at a maximum so that there is no eta phase.

4. Hard metal tool in accordance with one or several of the items 1 to 3, at which the cobalt content is lower than 5% and is alloyed with molybdenum up to the solubility limit at the most, at which the molybdenum content is generated by the integration of the metal, nitride, or oxide of the same.

5. Hard metal tool in accordance with one or several of the items 1 to 4, at which the binder phase contains one, two, or three mixed phases selected from austenitic phase, martensitic phase, and tetragonally deformed martensitic phase.

6. Hard metal tool in accordance with one or several of the items 1 to 5, at which the binder phase contains 5 to 30 weight % of chrome in addition and the sum of the percentage parts of the metals Co, Ni, Cr, and Fe is lower than or equal to 100 weight %.

7. Hard metal tool in accordance with one or several of the items 1 to 6, at which the binder phase additionally contains up to 5 mass percent of V, Mo, and/or Al and/or Ti, W, Ta/Nb, Zr, and/or Hf in a share smaller than or equal to the solubility limit of the corresponding material in each case, and/or up to 15 mass percent of Mn.

8. Hard metal tool in accordance with one or several of the items 1 to 7, at which the binder phase additionally contains oxygen, nitrogen, and/or boron in the share of their maximum solubility or less.

9. Hard metal tool in accordance with one or several of the items 1 to 8, at which the share of carbon within the binder phase is adjusted in a way that there are no separations of loose carbon.

10. Hard metal tool in accordance with one or several of the items 1 to 9, at which the coating is characterised by or consists of at least one refractory metal nitride, boron nitride, diamond, oxide, sulphides, or the mixtures of the same.

11. Hard metal tool in accordance with one or several of the items 1 to 10, at which the coating is characterised by or consists of titanium nitride, titanium aluminium nitride TiAIN, TiCN, aluminium oxide, TiTaNbC, tungsten carbon, or mixtures of the same.

12. Hard metal tool in accordance with one or several of the items 1 to 11, at which the coating is characterised by at least two layers, preferably with different layer thicknesses and/or several coating materials.

13. Hard metal tool in accordance with one or several of the items 1 to 12, at which the coating is characterised by a layer sequence of TiN/TiCN/Al₂O₃/TiN or TiN/TiCN7Al₂O₃/TiN.

14. Hard metal tool in accordance with one or several of the items 1 to 13, at which the thickness of the coating is between 0.5 μm and 100 μm, preferably between 1 μm and 50 μm, advantageously between 2 μm and 20 μm, particularly between 3 μm and 10 μm.

15. Hard metal tool in accordance with one or several of the items 1 to 14, at which the average grain size of the hard material phase is between 0.1 and 10 μm, preferably between 0.2 and 7 μm, particularly between 0.3 and 4 μm or 0.5 and 4 μm or 1 and 3 μm.

16. Hard metal tool in accordance with one or several of the items 1 to 15, at which the binder phase does not contain any hexagonal shares.

17. Hard metal tool in accordance with one or several of the items 1 to 16, at which the hard material phase is characterised by carbides, nitrides, and/or carbon nitrides, preferably refractory metals, and/or the mixtures of the same.

18. Hard metal tool in accordance with one or several of the items 1 to 17, at which the hard material phase is characterised by tungsten carbide or the mixed crystals of the same.

19. Hard metal tool in accordance with item 18, at which additionally at least one further cubic carbide phase or mixed carbide phase is contained and the share of cubic carbide phase may be up to 30 weight %.

20. Procedure for producing a hard metal tool in accordance with one or several of the items 1 to 19, at which the same is characterised by the following steps:
Provision of a binder metal powder of the composition in accordance with one or several of the claims mentioned above;
Provision of a hard material powder;
Mixing hard material and binder metal powder in order to obtain a first mixture;
Pressing the first mixture to form a blank;
Sintering the blank to become a sintered object;
If applicable, mechanic reworking of the sintered object;
Application of the coating in accordance with one or several of the claims mentioned above.

21. Procedure for producing a hard metal tool in accordance with item 20, at which the hard material powder is characterised by an average grain size of 0.3 to 10 μm, preferably 0.5 to 7 μm, particularly 1 to 4 μm.

22. Procedure for producing a hard metal tool in accordance with item 20 or 21, at which the hard material is characterised by a BET surface area of 0.1 m²/g to 8 m²/g, preferably 0.2 m²/g to 6 m²/g, or 0.1 m²/g to 4 m²/g, particularly 0.25 m²/g to 4.5 m²/g, or 0.3 m²/g to 4 m²/g or 5 m²/g.

23. Procedure for producing a hard metal tool in accordance with one or several of the items 20 to 22, at which the hard material is tungsten carbide, tungsten di-carbide, or a mixture of these materials.

24. Use of a hard metal tool in accordance with one or several of the items 1 to 19 for machining metal workpieces or non-metal workpieces.

25. Use of a cutting material in accordance with item 24 for machining chrome-containing metal workpieces, characterised by the fact that the share of chrome within the binder phase of the cutting material is not higher than the share of chrome within the steel alloy of the workpiece.

26. Use in accordance with item 24 or 25, at which this metal workpiece is a workpiece consisting of steels, cast irons, stainless steels, as well as non-ferrous basic alloys such as super alloys, aluminium, brass, titanium, or plastics, fibre composite materials.

### COMPREHENSIVE DESCRIPTION OF THE INVENTION

Now, a hard metal tool for machining metal alloys is sought for, at which the cobalt content of the binder has to be as low as possible.

In order to sum it up, it can be stated that too strong an adhesion and a lack of thermal resistance are the main reasons for failure of the hard metal tools in accordance with the state-of-the-art. Thus, it has not been disclosed up to this point in time that operational hard metal tools for machining corresponding metal workpieces have actually been combined on the basis of existing solutions.

Thus, the assignment of the present invention was to provide for an operational hard metal cutting tool characterised by reduced adhesion wear and increased thermal resistance so that the same is suitable as hard metal tool for machining alloys such as steels, cast irons, stainless steels, as well as non-ferrous alloys, such as super alloys.

The hard metal tool solves this assignment in accordance with the present invention. Thus, the hard metal tool in accordance with the invention is characterised by the following features:

1) a coating,

and

2) a) a binder phase on the basis of FeCoNi that is at least partially austenitic at room temperatures and characterised by 5 to 40% of Co, 90 to 20% of Fe, Ni min 5% to max 75% (at which, irrespective of the other components of the binder, the sum always has to be calculated at 100%), furthermore, also W and/or C as result of the sintering procedure as binder for hard metals on WC basis, if applicable, also Cr and/or Mo when using corresponding carbide, nitride, or metal powders.

3) a geometry that is suitable for machining metallic materials and for being supported in a tool support.

The claimed range for cobalt is a compromise between the inhalation toxicity of the powdery binder alloy in contact with WC increasing above 40% on the one hand, and the solubility of tungsten within the binder reduced with a reduction of the cobalt content on the other hand. Below a value of 5% cobalt the solubility of tungsten becomes too low so that tungsten has to be replaced by molybdenum that has better solubility values. The aforementioned is not implemented in form of carbidic molybdenum compounds that may form mixed carbides with for example tungsten carbide during sintering to undesired extents and thus make the binder ineffective, but in form of metallic nitrides or nitrides decomposing during the sintering procedure so that metallic molybdenum dissolves immediately within the binder and, thus, is available to the full extent to increase the thermal resistance of the binder.

Above a value of 5% cobalt this mechanism can be used as well, but it is not mandatory.

Hard metal tools in accordance with the present invention are characterised by a defined geometry, the assignment of which is to insert the tool into a tool support accepting the cutting forces in a non-positive manner, to have the chip be formed and broken in a targeted manner, and to dissipate the resulting heat together with the chip removal, if possible. Usual geometries of so-called replaceable cutting inserts are suitable. The same are often characterised by basic geometries derived from a rectangular prism or a plate, often with a hole arranged in the centre, and one or several cutting edges with a honing produced in a targeted manner, e.g. rectangular, hexagonal, or octagonal plates. Other cutting tools, such as for example for separating, are self-supporting thanks to their geometry and only dispose of one cutting edge. Often, the surface is also characterised by pimples or reliefs, in order to minimise the contact area of the chip with the cutting tool.

The binder alloy can be both austenitic (cubic area-centred) and martensitic (cubic space-centred, if applicable, deformed tetragonally) and it can contain the mentioned two or three phases as a mixture. However, a high share of austenite is preferred on the basis of the good course of the thermal hardness with the temperature, which can be adjusted by means of the ratio of the components Fe, Co, and Ni in the binder phase.

To be a little more specific, the hard metal tool consists of a hard metal or cermets cutting material for machining metal workpieces (e.g. steels, cast iron, stainless steels, as well as non-ferrous basic alloys, such as super alloys) with a hard material phase containing carbides, nitrides, and/or carbon nitrides, a binder phase consisting of iron, cobalt, and nickel, containing 5 to 40% of cobalt, 90 to 20% of iron, and 5 to 75% of nickel, at which the shares add up to 100%, as well as a coating.

The quantity of the binder phase contained within the hard metal tool is 3 to 40 weight %, advantageously 5 to 20 weight % and the hard material phase, at which both phases add up to 100%. Additionally, for example diamond, intermetallic phases, or an oxide increase may be present.

Furthermore, the invention refers to the use of the hard metal tool for machining metal workpieces.

Within the framework of hard metals such as cermets the binder serves for forming a liquid phase at sintering temperature that is able to consist in balance with the hard material phase and to sprinkle the same. The liquid binder phase is to be characterised by a noticeable solubility for the hard material phase at the sintering temperature, but is to separate the same when cooling down. Furthermore, the binder phase is to be characterised by mechanical properties corresponding to the purpose of application and the temperatures present in this in a way that the binder results in a coherence of the hard metal or cermets body that is as hard and rough as possible.

During machining operations such as turning, milling, or drilling of steel types, particularly austenitic steels, the hard metal or cermets cutting material cementing with the steel workpiece can be observed frequently despite the suitable geometry, at which the same is not desired on the basis of the increased wear of the cutting tool and the worse processing quality on the workpiece resulting thereof.

This issue is also solved on the basis of the present invention, because the coating shows an advantageous effect here.

In accordance with the invention the binder phase has 0 weight % to 40 weight % of Co, 5 weight % to 75 weight % of Ni, 20 weight % to 90 weight % of Fe. Furthermore, within the framework of a further embodiment of the invention 5 weight % to 30 weight % of Cr may be contained, at which the sum of the metals Co, Ni, Cr, and Fe does not exceed a value of 100%. In case of cobalt-free binder metals cobalt may occur as unavoidable contamination. This way, the binder phase may additionally contain up to 5 weight % of V, Mo, and/or Al in each case, up to the solubility limit Ti, W, Ta/Nb, Zr, and/or Hf, as well as up to 15 weight % of Mn. Moreover, oxygen, nitrogen, and/or boron may be contained within the binder up to the maximum solubility. The carbon content within the cutting material is adjusted in a way that, at the most, traces of eta phases and no separations of loose carbon are present. Preferably, the binder phase does not dispose of any hexagonal shares.

The binder phase within the tool in accordance with the invention is obtained by means of using a binder metal powder with the desired composition to produce the tool. The binder metal powder used to produce the tool can be obtained on the basis of usual procedures, such a mixing the element powders of the metals within the binder metal powder, or by atomising a molten alloy of the desired composition. Pre-alloyed powders are suited particularly for the aforementioned, at which the same can be obtained in the desired composition by precipitation of metal salt solutions in suitable precipitation agents and subsequent reduction, as described in WO 97/21844

U.S. Pat. No. 8,102,454, U.S. Pat. No. 5,912,399, WO 00/23,631, EP1079950 for example. Such pre-alloyed alloy powders can also be used in mixture with element powders as binder metal powder, as described in WO2008/034903.

Although the mechanisms of the reactions and interactions between the metals contained within the steel and carbon are very complex, surprisingly the procedure of machining metal workpieces showed that excellent results can be achieved when the tool is coated.

Generally known carbides, nitrides, and/or carbon nitrides, preferably those of the refractory metals, as well as the mixtures and mixed crystals with cubic carbides may be used as hard material phase, such as for example TiTaNbC. In this, tungsten carbide is particularly advantageous. In general, the hard material phase is used in form of powders. The average grain sizes (in accordance with ASTM-B-330, FSSS) of the used hard material powders are mostly between 0.3 μm and 10 μm, preferably between 0.4 μm and 7 μm, or between 0.5 μm and 4 μm. The used hard material powders are normally characterised by BET surface areas of less than 0.1 m²/g to 4 m²/g.

However, it is also possible to use hard material powders with BET surface areas between 0.1 m²/g and 8 m²/g, advantageously between 0.2 m²/g and 6 m²/g, particularly between 0.25 m²/g and 4.5 m²/g, or between 0.3 m²/g and 4 m²/g or 5 m²/g.

It is also possible to use a mixture of different powder qualities, e.g. a tungsten carbide powder with an average grain size of 1 μm mixed with a tungsten carbide powder with an average grain size of 5 μm.

In a further embodiment of the invention, a mixture of tungsten carbide (WC) and tungsten di-carbide (W₂C) is used as hard material phase. The mixture can be present as powder mixture or as a mixture of the two substances within the powder particles.

However, it is also possible to use hard material powders, particularly tungsten carbide powders, with BET surface areas between 1 m²/g and 8 m²/g, advantageously between 2 m²/g and 6 m²/g, particularly between 2.5 m²/g and 4.5 m²/g, or between 3 m²/g and 4 m²/g or 5 m²/g.

The coating consists of a refractory metal nitride, boron nitride, diamond, oxides, sulphides, or the mixtures of the same. Titanium nitride TiN, titanium aluminium nitride TiAIN, TiCN, TiAlSiN, Al₂O₃, TiTaNbC, MoS₂ or the mixtures of the same are particularly suitable. Some meta-stable or amorphous coatings are suitable as well, such as for example TiAIN or tungsten/carbon.

Furthermore, multiple-layer coatings are also possible containing different layer thicknesses and coating materials. Possible layer sequences are for example TiN/TiCN, Al₂O₃/TiN, TiN/TiCN, Al₂O₃/TiN. Usual thicknesses of the coating are between a few μm and a couple of 100 μm. The overall thickness of the coatings is between 1 μm and 50 μm, advantageously between 2 μm and 20 μm, and particularly between 3 μm and 10 μm in most cases.

These coatings are applied by means of CVD (chemical vapour deposition), PVD (physical vapour deposition), or related procedures.

If applicable, the hard metal substrate is modified as regards to its composition on the surface or in the areas near the surface before applying the coating by means of sintering or subsequent treatments in a way that the layer adhesion is ideal.

In general, the coating is adapted very specifically to the material to be machined and to the hard metal. Preferably the coating is under compressive stress; tensile stresses often result in cracks and spalling.

The hard metal tools in accordance with the invention are used for machining metal workpieces or non-metal workpieces.

In doing so, these may be chrome-containing metal workpieces, at which the share of chrome within the binder phase of the cutting material, i.e. the material the hard metal tool is made of in accordance with the invention, is not higher than the share of chrome within the steel alloy of the workpiece.

Furthermore, the workpiece may be made of steels, cast irons, stainless steels, as well as non-ferrous basic alloys, such as super alloys, aluminium, brass, or titanium. Non-metal materials can be processed as well, such as for example fibre composite materials or thermoplastic or duroplastic plastic materials, at which the same may also be reinforced with fibres such as glass or carbon fibres, fillers, or other reinforcement materials, such as for example nanocomposites.

The present invention also refers to a procedure as regards to the production of a hard metal tool in accordance with one or several of the claims mentioned above, at which the same is characterised by the following steps:
Provision of a binder metal powder of the composition in accordance with the invention;
Provision of a hard material powder;
Mixing hard material and binder metal powder in order to obtain a first mixture;
Pressing the first mixture to form a blank;
Sintering the blank to become a sintered object;
If applicable, mechanic reworking of the sintered object;
Application of the coating in accordance with the invention

Suitable binder metal powders and hard material powders are described above.

Within the framework of a particular embodiment of the invention, the binder metal powder can be provided due to the production of a pre-alloyed metal powder in the desired composition, described in WO 97/21844 U.S. Pat. No. 8,102,454, U.S. Pat. No. 5,912,399, WO 00/23631, EP1079950, at which references are made to the aforementioned. Within the framework of a further embodiment of the invention, the binder metal powder may be provided by means of mixing a pre-alloyed metal powder with one or several element powders, i.e. metal powders, consisting of one metal only, as described in WO2008/034903, at which references are made to the aforementioned.

Advantageously, the hard material powder is characterised by an average grain size of 0.3 to 10 μm, preferably 0.5 to 7 μm, particularly 1 to 4 ρm. The hard material powder is characterised by a BET surface area of 0.1 m²/g to 8 m²/g, advantageously of 0.2 m²/g to 6 m²/g, or 0.1 m²/g to 4 m²/g, particularly from 0.25 m²/g to 4.5 m²/g, or from 0.3 m²/g to 4 m²/g or 5 m²/g. Advantageously, tungsten carbide or a mixture from these substances can be used as hard material.

The mixing procedure can be implemented advantageously by a common wet grinding procedure, for example in a suspension.

The first mixture can also contain pressing or sintering aids, such as for example wax materials, long-chained carboxylic acids, the esters and salts of the same, or polymers such as polyethylene glycol, or polyacrylates.

The procedure of blank pressing is normally implemented as uniaxial pressing procedure and at pressures between 50 and 250 MPa in general.

The sintering procedure is implemented at temperatures between 1200° C. and 1600° in most cases, particularly between 1250° C. and 1550° C., in an inert atmosphere or in the vacuum.

### EXAMPLES

### Example 1

A hard metal powder mixture consisting of 94 weight % WC with a grain size of 0.8 micron (ASTM B330) and a binder content of 6 weight %, consisting of 70Fe12Co18Ni, has been generated by wet grinding in a grinding mill and processed in a conventional spray dryer to become granulated material. The carbon content of the mixture has been adjusted in a way that the hard metal does not contain any hazardous third phases upon sintering, such as for example free carbon or carbon deficit phases (eta phases). Hard metal replaceable cutting inserts with geometries in accordance with type CNMG120408 have been produced as follows: a pellet has been produced by axial dry pressing. Afterwards, the same has been sintered in a graphite sinter oven at 1450° C. over a period of one hour in the vacuum. The metallographic inspection of the semi-finished hard metal products showed that the hard metal was characterised by a uniform structure with a WC grain size of approx. 0.6 micron. The binder distribution was good and very few WC coarse grains up to a grain size of 3 micron were observed. The hardness of the hard metal was 1920 kg/mm² (Vickers hardness at a load of 10 kg, “HV10”). The radiographic inspection showed that the binder predominantly consists of martensite and a little bit of residual austenite.

The blanks for the hard metal replaceable cutting inserts were ground to measure, the cutting edges were honed, and coated with a PVD coating on the basis of TiAIN usual in the industry afterwards. Lifetime tests have been implemented while turning without the use of coolant at a cutting speed of 250 m/min, feed 0.3 mm/rotation, cutting depth 2 mm, in a low-alloy steel of the type 42CrMo4.

Comparative example 1): The lifetime of a conventional WC-Co hard metal of the same geometry, the same coating, and the same composition, but bound to cobalt exclusively, was 5 minutes in comparison, while a lifetime of 6 minutes could by achieved with the WC-70Fe12Co18Ni hard metal in example 1 under the same machining conditions. The criterion for the end of the lifetime was a width of the wear mark (“VBmax”) of 0.2 mm.

### Example 2

A hard metal powder mixture consisting of 94 weight % WC with a grain size of 0.8 micron and a binder content of 6 weight %, consisting of 50Fe25Co25Ni, has been generated as conventionally usual and described above. The hardness of the sintered hard metals was 1850 kg/mm² (HV10). The structure was very uniform without WC coarse grains >2 micron. The binder was purely austenitic. The sintered blanks for the replaceable cutting inserts were ground to measure and a part of the same was coated with a usual PVD coating on the basis of TiAIN with a layer thickness of approx. 5 μm. A different part of the replaceable cutting inserts was coated with a typical CVD coating on the basis of TiN/TiCN/Al₂O₃/TiN with an overall layer thickness of 8 micron. These replaceable cutting inserts coated with PVD respectively CVD were tested within the framework of a lifetime test while turning steel 42CrMo4 at a cutting speed of 220 m/min in a CNC-controlled processing centre.

Comparative example 2): The WC-Co replaceable cutting inserts produced for comparison purposes characterised by the same composition showed a lifetime of 6 minutes in uncoated form, at which the WC-50Fe25Co25Ni replaceable cutting inserts coated with PVD were characterised by a lifetime of 8.5 minutes and the replaceable cutting inserts coated with CVD with the same substrate were characterised by a lifetime of 8.0 minutes. The criterion for the end of the lifetime was a width of the wear mark VBmax of 0.2 mm. The lower lifetime of the WC-Co replaceable cutting inserts was related to a higher plastic deformation of the cutting edge and a correspondingly worse surface structure of the workpiece.

### Example 3

A hard metal powder mixture consisting of 83.5 weight % WC with a grain size of 1.1 μm, a mixed carbide present as mixed crystal consisting of TiTaNbC of 8%, and a binder content of 8.5 weight %, consisting of 70Fe12Co18Ni, has been generated by wet grinding in a grinding mill and processed in a conventional spray dryer to become granulated material. The carbon content of the mixture has been adjusted in a way that the hard metal does not contain any hazardous third phases upon sintering, such as for example free carbon or eta phases. Hard metal replaceable cutting inserts with of the type CNMG120408 have been produced and sintered in a graphite sinter over at 1450° C. over a period of one hour in the vacuum afterwards. The metallographic inspection of the semi-finished hard metal product showed that the hard metal was characterised by a uniform structure with a WC grain size of approx. 1.2 micron and a mixed crystal grain size of 1 micron. The binder distribution was uniform. The hardness of the hard metal was 1600 kg/mm2 HV10 and the radiographic inspection showed that the binder predominantly consists of martensite and a little bit of residual austenite.

The blanks for the hard metal replaceable cutting inserts were ground to measure, the cutting edges were honed, and coated with a usual CVD multiple-layer coating on the basis of TiN/TiCN/Al₂O₃/TiN with an overall layer thickness of 8 micron. Lifetime tests have been implemented while turning without the use of coolant at a cutting speed of 200 m/min, feed 0.32 mm/rotation, cutting depth 2 mm, in a low-alloy steel of the type 42CrMo4.

Comparative example 3): The lifetime of a conventional hard metal WC-TiCTaC-Co (type P20/P25) was 10 minutes, at which the same was characterised by the same geometry, the same coating, and the same composition. A lifetime of 12 minutes could by achieved with the WC-TiC-TaC-70Fe12Co18Ni hard metal under the same machining conditions. The criterion for the end of the lifetime was a width of the wear mark VBmax of 0.2 mm.

The conventional, cobalt-bound hard metal tool showed a distinctive plastic deformation of the cutting edge at the end of the lifetime, while the FeCoNi-bound hard metal tool showed a certain crater wear and free surface wear. The coating showed signs of wear, but was still intact. No signs for adhesion wear could be observed.

1.-16. (canceled)

17. A hard metal tool comprising a composite object and a coating suitable for metal machining disposed on a surface of the composite object, wherein the composite object comprises a hard material phase and a binder phase, the binder phase comprising 0 to 40 weight % of cobalt, 20 to 90 weight % of iron, and 5 to 75 weight % of nickel, based on the binder phase, and wherein the hard metal tool has a geometry suitable for metal machining.

18. The hard metal tool according to claim 17, wherein the binder phase further comprises one or both of chromium and molybdenum in an amount up to an extent such that there is no eta phase present.

19. The hard metal tool according to claim 18, wherein cobalt is present in an amount less than 5 weight %, and comprises molybdenum, present as the metal, nirtirde or oxide thereof, in an amount up to its solubility limit.

20. The hard metal tool according to claim 18, comprising chromium in an amount of 5 to 30 weight %.

21. The hard metal tool according to claim 17, wherein the binder phase further comprises up to 5 mass percent of V, Mo, and/or Al and/or Ti, W, Wa/Nb, Zr, and/or Hf, in an amount less than or equal to the solubility limit of the corresponding material in each case, and/or up to 15 mass percent of Mn.

22. The hard metal tool according to claim 17, wherein the binder phase further comprises carbon and the amount of carbon within the binder phase is adjusted such that there are no separations of loose carbon.

23. The hard metal tool according to claim 17, wherein the coating comprises one or more materials selected from the group consisting of titanium nitride, titanium aluminum nitride, TiCN, aluminum oxide, TiTaNbC, tungsten carbon, or mixtures thereof.

24. The hard metal tool according to claim 17, wherein the coating comprises at least two layers.

25. The hard metal tool according to claim 24, wherein the at least two layers have different thicknesses and/or different compostions.

26. The hard metal tool according to claim 24, wherein the coating comprises a layer sequence selected from the group consisting of TiN/TiCN/Al₂O₃/TiN or TiN/TiCN7Al₂O₃/TiN.

27. The hard metal tool according to claim 17, wherein the coating has a thickness of 0.5 μm to 100 μm.

28. The hard metal tool according to claim 17, wherein the coating has a thickness of 1 μm to 50 μm.

29. The hard metal tool according to claim 17, wherein the coating has a thickness of 2 μm to 20 μm.

30. The hard metal tool according to claim 17, wherein the coating has a thickness of 3 μm to 10 μm.

31. The hard metal tool according to claim 17, wherein the hard material phase has an average grain size of 0.1 to 10 μm.

32. The hard metal tool according to claim 17, wherein the hard material phase has an average grain size of 1 to 3 μm.

33. The hard metal tool according to claim 17, wherein the hard material phase comprise carbides, nitrides, and/or carbon nitrides and/or the mixtures of the same, and contains up to 30 weight % of one or several cubic carbide phases.

34. A process for producing a hard metal tool, the process comprising:
(a) providing a binder metal powder of the composition according to claim 17;
(b) providing a hard material powder;
(c) mixing the hard material and binder metal powder to form a first mixture;
(d) pressing the first mixture to form a blank;
(e) sintering the blank to form a sintered object;
(f) optionally, mechanically reworking the sintered object; and
(g) applying a coating suitable for metal machining on a surface of the sintered object.

35. The process according to claim 34, wherein the hard material powder has an average grain size of 0.3 to 10 μm.

36. The process according to claim 34, wherein the hard material powder has an average grain size of 0.5 to 7 μm.

37. The process according to claim 34, wherein the hard material powder has an average grain size of 1 to 4 μm.

38. A method comprising providing a workpiece, and machining the workpiece with a hard metal tool according to claim 17.

39. The method according to claim 38, wherein the workpiece comprises a material selected from the group consisting of steels, cast iron, stainless steels, super alloys, aluminum, brass, titanium, plastics, fibre composite materials and combinations thereof.
